(19) United States
(12) Patent Application Publication
(10) Pub. No.: US 2025/0199217 A1
(43) Pub. Date: Jun. 19, 2025

(54) OPTICAL FILTER

(71) Applicant: AGC Inc., Tokyo (JP)

(72) Inventors: Kazuhiko SHIONO, Fukushima (JP); Takashi NAGATA, Shizuoka (JP)

(73) Assignee: AGC Inc., Tokyo (JP)

(21) Appl. No.: 18/967,781

(22) Filed: Dec. 4, 2024

(30) Foreign Application Priority Data
Dec. 13, 2023 (JP) 2023-210431

(51) Int. Cl. G02B 5/20

(52) U.S. Cl. CPC G02B 5/208

(57) ABSTRACT

An optical filter according to an embodiment includes: a dielectric multilayer film 1; a light-absorbing layer; a glass substrate; and a dielectric multilayer film 2 in this order, in which the light-absorbing layer includes a near-infrared ray absorbing dye, and the optical filter satisfies all of spectral characteristic (i-1) to spectral characteristic (i-6).

### CROSS-REFERENCE TO RELATED APPLICATIONS

This application claims priority from Japanese Patent Application No. 2023-210431 filed on Dec. 13, 2023, the entire subject matter of which is incorporated herein by reference.

### TECHNICAL FIELD

The present invention relates to an optical filter.

### BACKGROUND ART

For an imaging device including a solid state image sensor, an application thereof is extended to a device that takes an image anytime during day and night, such as a monitoring camera or an in-vehicle camera. In such a device, it is necessary to acquire (color) images based on visible light and (monochrome) images based on infrared light.

Therefore, there has been studied use of an optical filter having, in addition to a near-infrared ray cut filter function for transmitting visible light and correctly reproducing an image based on the visible light, a function of selectively transmitting specific near-infrared light, that is, a dual band pass filter.

Patent Literature 1 discloses an optical filter in which a dielectric multilayer film and a resin substrate containing a near-infrared ray absorbing dye are combined, and near-infrared light around 850 nm and visible light are transmitted and other light is shielded.

Patent Literature 2 discloses an optical filter in which a dielectric multilayer film and a resin substrate containing a near-infrared ray absorbing dye are combined, and near-infrared light around 940 nm and visible light are transmitted and other light is shielded.

### CITATION LIST

### Patent Literature

Patent Literature 1: WO2017-030174
Patent Literature 2: JP2016-200771A

### SUMMARY OF INVENTION

In recent years, with a diversification of sensing regions in the field of imaging, laser light including a partial near-infrared light region of 1,000 nm or more, of which a wavelength region is different from those in Patent Literatures 1 and 2, is used. Accordingly, there is a demand for an optical filter capable of transmitting near-infrared light in such sensing regions and shielding other near-infrared light which becomes a noise.

In an optical filter including a dielectric multilayer film, since an optical film thickness of the dielectric multilayer film changes depending on an incident angle of light, there is such a problem that a spectral transmittance curve changes depending on the incident angle. For example, as the incident angle of light increases, reflection characteristics shift to a short wavelength side, and as a result, the reflection characteristics may deteriorate in a region to be originally shielded. Such a phenomenon is likely to occur more strongly as the incident angle is larger. When such a filter is used, spectral sensitivity of the solid state image sensor may be affected by the incident angle. With a reduction in height of camera modules in recent years, use under a condition of a high incident angle is assumed, and therefore an optical filter that is hardly affected by an incident angle is required.

An object of the present invention is to provide an optical filter that has excellent transmittance for visible light and specific near-infrared light, excellent shielding properties for other near-infrared light, and a small shift of a spectral curve even at a high incident angle.

The present invention provides an optical filter having the following configuration.

According to the present invention, an optical filter that has excellent transmittance for visible light and specific near-infrared light and excellent shielding properties for other near-infrared light can be provided. The optical filter of the present invention is particularly excellent in transmittance in a near-infrared light region of 1,000 nm to 1,300 nm including a sensing wavelength region. Further, the optical filter is an optical filter in which a spectral transmittance curve of a boundary region between a visible light transmission region and a wavelength region on a long wavelength side to be shielded hardly shifts depending on an incident angle and is hardly affected by the incident angle.

### BRIEF DESCRIPTION OF DRAWINGS

FIG. 1 is a cross-sectional view schematically illustrating an example of an optical filter according to one embodiment.

FIG. 2 is a cross-sectional view schematically illustrating another example of the optical filter according to one embodiment.

FIG. 3 is a diagram illustrating spectral transmittance curves of glass.

FIG. 4 is a diagram illustrating spectral transmittance curves of light-absorbing layers.

FIG. 5 is a diagram illustrating spectral transmittance curves of an optical filter in Example 1.

FIG. 6 is a diagram illustrating spectral reflectance curves of the optical filter in Example 1.

FIG. 7 is a diagram illustrating spectral transmittance curves of an optical filter in Example 5.

### DESCRIPTION OF EMBODIMENTS

Hereinafter, embodiments of the present invention will be described.

In the present description, a near-infrared ray absorbing dye may be abbreviated as an “NIR dye”, and an ultraviolet absorbing dye may be abbreviated as a “UV dye”.

In the present description, a compound represented by a formula (I) is referred to as a compound (I). The same applies to compounds represented by other formulae. A dye composed of the compound (I) is also referred to as a dye (I), and the same applies to other dyes. In addition, a group represented by the formula (I) is also referred to as a group (I), and the same applies to groups represented by other formulae.

In the present description, spectra of transmittance of glass, transmittance of a light-absorbing layer including a case where a dye is contained in a resin, transmittance measured by dissolving a dye in a solvent such as dichloromethane, transmittance of a dielectric multilayer film, and transmittance of an optical filter having the dielectric multilayer film are all “external (measured) transmittance” including reflection losses of front and back surfaces even when described as “transmittance”.

In the present description, transmittance of, for example, 90% or more in a specific wavelength region means that the transmittance does not fall below 90% in the entire wavelength region, that is, minimum transmittance is 90% or more in the wavelength region. Similarly, transmittance of, for example, 1% or less in a specific wavelength region means that the transmittance does not exceed 1% in the entire wavelength region, that is, maximum transmittance is 1% or less in the wavelength region. Average transmittance in the specific wavelength region is an arithmetic mean of transmittance per 1 nm in the wavelength region.

Spectral characteristics can be measured by using an ultraviolet-visible spectrophotometer.

In the present description, the symbol “-” or the word “to” that is used to express a numerical range includes the numerical values before and after the symbol or the word as the upper limit and the lower limit of the range, respectively.

### <Optical Filter>

An optical filter according to one embodiment of the present invention (hereinafter, also referred to as “the filter”) is an optical filter including a dielectric multilayer film 1, a light-absorbing layer, a glass substrate, and a dielectric multilayer film 2 in this order, in which the light-absorbing layer contains a near-infrared ray absorbing dye.

Reflection characteristics of the dielectric multilayer film and absorption characteristics of the light-absorbing layer allow the optical filter as a whole to achieve excellent transmittance in a visible light region and a specific near-infrared light region, and excellent shielding properties in another near-infrared light region.

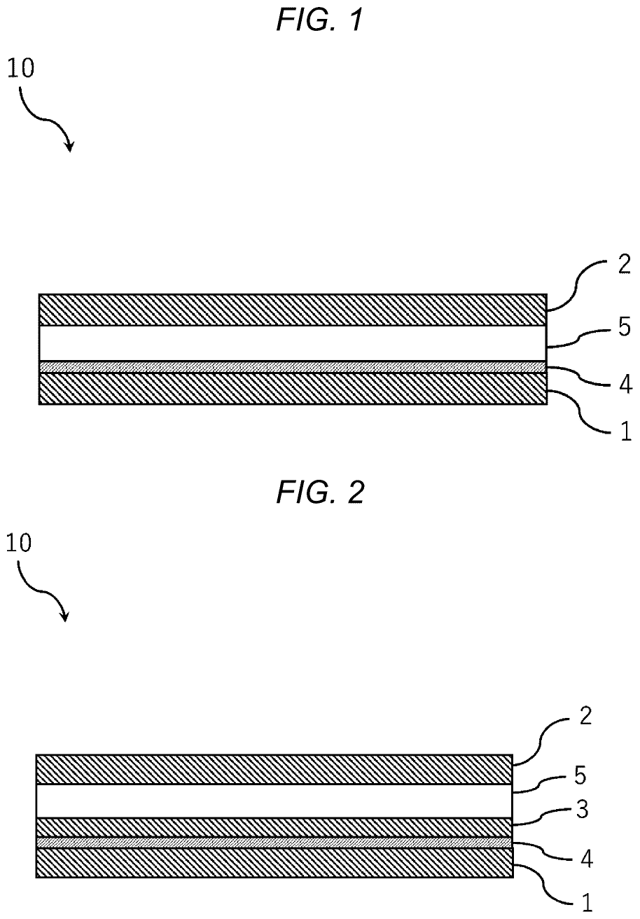

An example of a configuration of the filter will be described with reference to the drawings. FIGS. 1 and 2 are cross-sectional views schematically illustrating examples of the optical filter according to one embodiment.

An optical filter 10 illustrated in FIG. 1 is an example in which the dielectric multilayer film 1, a light-absorbing layer 4, a glass substrate 5, and the dielectric multilayer film 2 are provided in this order.

An optical filter 10 illustrated in FIG. 2 is an example in which the dielectric multilayer film 1, the light-absorbing layer 4, a dielectric multilayer film 3, the glass substrate 5, and the dielectric multilayer film 2 are provided in this order.

The filter satisfies all of the following spectral characteristics (i-1) to (i-6).
(i-1) An average transmittance of a light having a wavelength of 450 nm to 600 nm at an incident angle of 0 degrees is 85% or more.
(i-2) An absolute value of a difference between a wavelength at which a transmittance of a light having a wavelength of 550 nm to 750 nm is 50% at an incident angle of 0 degrees and a wavelength at which a transmittance of a light having a wavelength of 550 nm to 750 nm is 50% at an incident angle of 30 degrees is 10 nm or less.
(i-3) An average transmittance of a light having a wavelength of 725 nm to 1,000 nm at an incident angle of 0 degrees is 1% or less.
(i-4) A wavelength IR50 at which a transmittance of a light at an incident angle of 0 degrees is 50% is in a range of 1,000 nm to 1,150 nm.
(i-5) An average transmittance of a light having a wavelength of 1,100 nm to 1,200 nm at an incident angle of 0 degrees is 80% or more.
(i-6) An absolute value of a difference between a wavelength at which a reflectance of a light at an incident angle of 5 degrees is 25% and a wavelength at which the reflectance is 85% in a wavelength of 550 nm to 850 nm is 20 nm or less when the light is incident from at least one main surface of the optical filter.

Satisfying the spectral characteristic (i-1) means that the transmittance of visible light is excellent, and by satisfying the spectral characteristic (i-1), a captured amount of light in a wavelength region of a camera module is large, and higher sensing is possible.

The average transmittance in the spectral characteristic (i-1) is preferably 86% or more, and more preferably 87% or more.

In order to satisfy the spectral characteristic (i-1), for example, a dielectric multilayer film having low reflectance in the visible light region may be provided, or a plurality of kinds of near-infrared ray absorbing dyes may be used to control visible light absorbing properties.

Satisfying the spectral characteristic (i-2) means that a shift of a spectral curve is small even at a high incident angle in a boundary region (cut edge) on a long wavelength side of the visible light transmission region. By satisfying the spectral characteristic (i-2), an optical filter can be obtained in which spectral sensitivity is excellent because a captured amount of visible light is less likely to change depending on the incident angle.

The above absolute value in the spectral characteristic (i-2) is preferably 8 nm or less, and more preferably 5 nm or less.

In order to satisfy the spectral characteristic (i-2), for example, light shielding in the boundary region on the long wavelength side of the visible light transmission region may be performed by the absorption characteristics of the near-infrared ray absorbing dye or a light-absorbing glass.

Satisfying the spectral characteristic (i-3) means that light shielding properties in a region between both transmission regions of visible light and near-infrared light having a specific wavelength are excellent, and as a result, an optical filter excellent in cutting properties of light in a region which becomes a noise can be obtained.

The average transmittance in the spectral characteristic (i-3) is preferably 0.9% or less.

In order to satisfy the spectral characteristic (i-3), for example, it is possible to combine reflection characteristics of both the dielectric multilayer films 1 and 2, combine near-infrared ray absorbing dyes having different maximum absorption wavelengths, use the light-absorbing glass, or the like to perform shielding in a wide region having a wavelength of 725 nm to 1,000 nm by combining a plurality of characteristics.

The spectral characteristic (i-4) means an index of a boundary region (cut edge) on a short wavelength side of a near-infrared light transmission region.

The wavelength IR50 in the spectral characteristic (i-4) is preferably in a range of 1,010 nm to 1,140 nm.

In order to satisfy the spectral characteristic (i-4), for example, the number of laminated layers of the multilayer film may be increased, or a difference in refractive index of a material used may be increased.

Satisfying the spectral characteristic (i-5) means that the transmittance of specific near-infrared light is excellent, and as a result, an optical filter capable of higher sensing with a larger captured amount of light in a sensing wavelength region can be obtained.

The average transmittance in the spectral characteristic (i-5) is preferably 83% or more, and more preferably 85% or more.

In order to satisfy the spectral characteristic (i-5), for example, a dielectric multilayer film having low reflection characteristics for the light having a wavelength of 1,100 nm to 1,200 nm may be used, or light on a wavelength side shorter than a wavelength of 1,100 nm may be shielded by the near-infrared ray absorbing dye or the light-absorbing glass.

The spectral characteristic (i-6) substantially means the reflection characteristics of the dielectric multilayer film 1 or the dielectric layer film 2. By satisfying the spectral characteristic (i-6), a reflection curve of the dielectric multilayer film rises in a wavelength range of 550 nm to 850 nm, and means that a rising width is steep. As a result, an optical filter having high spectral sensitivity can be obtained without lowering the transmittance in the visible light region.

An incident surface in the spectral characteristic (i-6) is preferably on a dielectric multilayer film 2 side.

The absolute value in the spectral characteristic (i-6) is preferably 17 nm or less. In order to satisfy the spectral characteristic (i-6), for example, the dielectric multilayer film 1 or the dielectric multilayer film 2 designed to have the above reflection characteristics may be used.

The filter preferably satisfies the following spectral characteristic (i-7).
(i-7) An absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.

The above absolute value of the difference between the wavelengths corresponds to a distance between the visible light transmission region and the near-infrared light transmission region. The above absolute value is more preferably 350 nm or more.

In order to satisfy the spectral characteristic (i-7), in particular, in order to sufficiently separate a position of the near-infrared light transmission region from the visible light transmission region, for example, it is possible to combine reflection characteristics of both the dielectric multilayer films 1 and 2, combine near-infrared ray absorbing dyes having different maximum absorption wavelengths, use the light-absorbing glass, or the like to perform light shielding in a wide region by combining a plurality of characteristics.

The filter preferably satisfies the following spectral characteristic (i-8).
(i-8) An absolute value of a difference between an average transmittance of a light having a wavelength of 1,100 nm to 1,200 nm at an incident angle of 0 degrees and an average transmittance of the light having a wavelength of 1,100 nm to 1,200 nm at an incident angle of 30 degrees is 6% or less.

By satisfying the spectral characteristic (i-8), an optical filter excellent in transmittance of near-infrared light even at a high incident angle and having a small change in the amount of light of a sensor is preferably obtained.

The absolute value in the spectral characteristic (i-8) is more preferably 5.5% or less.

In order to satisfy the spectral characteristic (i-8), for example, transmittance cutting properties in 1,100 nm to 1,200 nm is sufficient.

The filter preferably satisfies the following spectral characteristic (i-9).

When a light is incident from either of the main surfaces, an (absorption loss amount)_{X} at a wavelength of X nm is defined as follows: (absorption loss amount)×[%]=100−(transmittance at incident angle of 0 degrees)−(reflectance at incident angle of 5 degrees). (i-9) A wavelength at which an absorption loss amount of light is 30% is in a range of 600 nm to 750 nm and in a range of 800 nm to 1,200 nm.

The (absorption loss amount)_{X} is an index indicating a shielding degree corresponding to absorption characteristics at a wavelength of X nm, and the larger a numerical value thereof is, the more the light of the wavelength X is shielded by absorption.

The wavelength in the spectral characteristic (i-9) is more preferably in a range of 605 nm to 700 nm and a range of 805 nm to 1,150 nm.

In order to satisfy the spectral characteristic (i-9), for example, a near-infrared ray absorbing dye having a maximum absorption wavelength between a wavelength region of 600 nm to 750 nm and a wavelength region of 800 nm to 1,200 nm may be used.

The filter preferably satisfies the following spectral characteristic (i-10).
(i-10) An absolute value of a difference between a wavelength at which a transmittance of a light having a wavelength of 950 nm to 1,150 nm is 50% at an incident angle of 0 degrees and a wavelength at which a transmittance of the light having a wavelength of 950 nm to 1,150 nm is 50% at an incident angle of 30 degrees is 70 nm or less.

Satisfying the spectral characteristic (i-10) means that a shift of a spectral curve is small even at a high incident angle in the boundary region (cut edge) on the short wavelength side of the near-infrared light transmission region (having a wavelength of 1,100 nm to 1,200 nm). By satisfying the spectral characteristic (i-10), an optical filter can be obtained in which spectral sensitivity is excellent because a captured amount of near-infrared light is less likely to change depending on the incident angle.

The above absolute value in the spectral characteristic (i-10) is more preferably 65 nm or less, and further preferably 60 nm or less.

In order to satisfy the spectral characteristic (i-10), for example, light shielding in the boundary region on the short wavelength side of the near-infrared light transmission region (having a wavelength of 1,100 nm to 1,200 nm) may be performed by the absorption characteristics of the near-infrared ray absorbing dye or the light-absorbing glass.

### <Glass Substrate>

The filter includes a glass substrate. Since the filter includes at least two dielectric multilayer films, a material having high rigidity such as glass is preferable instead of a resin film as a substrate. Thus, warpage during film formation can be reduced.

The glass substrate may be a transparent glass substrate or a light-absorbing glass substrate, and a light-absorbing glass substrate is preferable. The reflection characteristics of the dielectric multilayer film are such that the light shielding region is shifted depending on the incident angle of light. On the other hand, the absorption characteristics of the light-absorbing glass substrate are such that the shift of the light shielding region depending on the incident angle of light is small, and high light shielding properties can be exhibited even at a high incident angle.

The light-absorbing glass is preferably a glass containing ytterbium. The glass containing ytterbium has a characteristic of absorbing light in a near-infrared light region having a wavelength of 900 nm to 1,000 nm. Further, since a waveform of an absorption band is steep, transmittance in a region other than a maximum absorption wavelength region is excellent. Therefore, transmittance is excellent in the visible light region and in a region from visible light to near-infrared light having a wavelength of about 800 nm and on a wavelength side longer than a wavelength of 1,000 nm.

Each component that can constitute the glass and a preferred content thereof (in terms of mol % based on an oxide) will be described below. In the present description, unless otherwise specified, the content of each component and the total content are represented by mol % based on oxides.

Yb₂O₃ is a component for efficiently absorbing light having a wavelength around 900 nm to 1,000 nm, particularly light having a wavelength of 940 nm, and reducing the transmittance. In the glass of the present embodiment, when a content of Yb₂O₃ is 20% or more, an effect thereof can be sufficiently obtained, and when the content is 60% or less, problems such as deterioration of devitrification resistance of the glass, deterioration of meltability, and generation of stray light due to fluorescence are unlikely to occur.

Therefore, the content of Yb₂O₃ is preferably 20% to 60%, more preferably 25% to 60%, further preferably 30% to 60%, still more preferably 35% to 60%, particularly preferably more than 40% and 60% or less, and most preferably 45% to 60%.

SiO₂ is a main component that forms the glass, and is a component for improving devitrification resistance and viscosity with respect to a liquid phase temperature of the glass. In the glass of the present embodiment, when a content of SiO₂ is 0.1% or more, problems such as unstability of the glass, reduction in weather resistance, and generation of striae in the glass are unlikely to occur. When the content of SiO₂ is 50% or less, problems such as deterioration of glass meltability are unlikely to occur.

Therefore, the content of SiO₂ is preferably 0.1% to 50%, more preferably 0.1% to 40%, further preferably 0.1% to 30%, still more preferably 0.1% to 20%, particularly preferably 0.1% to 10%, and most preferably 0.1% to 9%.

B₂O₃ is a main component that forms the glass, and is a component for improving devitrification resistance and viscosity with respect to a liquid phase temperature of the glass. In the glass of the present embodiment, when a content of B₂O₃ is 15% or more, problems such as unstability of glass are unlikely to occur. When the content of B₂O₃ is 40% or less, problems such as reduction in weather resistance of the glass and generation of striae in the glass are unlikely to occur.

Therefore, the content of B₂O₃ is preferably 15% to 40%, more preferably 15% to 38%, further preferably 15% to 36%, still more preferably 15% to 34%, particularly preferably 15% to 32%, and most preferably 15% to 30%.

The light-absorbing glass preferably contains at least one of SiO₂ and B₂O₃ from the viewpoint of obtaining a stable glass. A total content of the above components is preferably more than 65% from the viewpoint of hardly causing problems such as unstability of glass, and is preferably 80% or less from the viewpoint of hardly causing problems such as deterioration of glass meltability.

Therefore, the total content is more preferably more than 65% and 79% or less, further preferably more than 65% and 78% or less, still more preferably more than 65% and 77% or less, particularly preferably more than 65% and 76% or less, and most preferably more than 65% and 75% or less.

P₂O₅ is a component for improving meltability and stability of the glass. In the glass of the present embodiment, a content of P₂O₅ is preferably 0% to 15%. When the content of P₂O₅ is 15% or less, problems such as deterioration in weather resistance of the glass, phase separation of the glass, and generation of striae in the glass are unlikely to occur.

The content of P₂O₅ is more preferably 1% to 13%, further preferably 2% to 12%, still more preferably 3% to 11%, and most preferably 4% to 10%.

GeO₂ is a component for improving devitrification resistance and viscosity with respect to a liquid phase temperature of the glass. In the glass of the present embodiment, a content of GeO₂ is preferably 0% to 15%. When the content of GeO₂ is 15% or less, problems such as deterioration in glass meltability are unlikely to occur.

The content of GeO₂ is more preferably 0% to 13%, further preferably 0% to 11%, still more preferably 0% to 9%, and most preferably 0% to 7%.

Ga₂O₃ is a component for increasing the Young's modulus of the glass and improving the meltability and the stability. In the glass of the present embodiment, a content of Ga₂O₃ is preferably 0% to 30%. When the content of Ga₂O₃ is 30% or less, problems such as deterioration of devitrification resistance of the glass, increase of reflectance, and generation of stray light due to reflected light are unlikely to occur.

The content of Ga₂O₃ is more preferably 0.5% to 28%, further preferably 1% to 26%, still more preferably 2% to 24%, and most preferably 3% to 22%.

ZrO₂ is a component for increasing the Young's modulus of the glass and improving viscosity with respect to a liquid phase temperature of the glass. In the glass of the present embodiment, a content of ZrO₂ is preferably 0% to 7%. When the content of ZrO₂ is 7% or less, problems such as deterioration of devitrification resistance of the glass and deterioration of meltability are unlikely to occur.

The content of ZrO₂ is more preferably 0% to 6%, further preferably 0% to 5%, still more preferably 0% to 4%, and most preferably 0% to 3%.

La₂O₃ is a component for increasing the Young's modulus of the glass and improving the meltability. In the glass of the present embodiment, a content of La₂O₃ is preferably 0.1% to 20%. When the content of La₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content of La₂O₃ is more preferably 0.5% to 19%, further preferably 1% to 18%, still more preferably 2% to 17%, and most preferably 2% to 16%.

Al₂O₃ is a component for increasing the Young's modulus of the glass and reducing the refractive index of the glass. In the glass of the present embodiment, a content of Al₂O₃ is preferably 0.1% to 20%. When the content of Al₂O₃ is 0.1% or more, an effect thereof is sufficiently obtained, and when the content is 20% or less, problems such as deterioration of devitrification resistance of the glass, increase of reflectance, and generation of stray light due to reflected light are unlikely to occur.

The content is more preferably 0.1% to 18%, further preferably 0.1% to 15%, still more preferably 0.1% to 13%, and most preferably 0.1% to 11%.

A ratio of a total content of components of Al₂O₃, GeO₂, Ga₂O₃, and P₂O₅ to a total content of components of SiO₂ and B₂O₃, that is, (total content of Al₂O₃, GeO₂, Ga₂O₃, and P₂O₅)/(total content of SiO₂ and B₂O₃) is preferably less than 0.1 from the viewpoint of vitrifying glass containing a Yb component without devitrifying the glass.

The light-absorbing glass may contain an alkali metal oxide, an alkaline earth metal oxide, Sb₂O₃, Cl, F, and other components as long as the object of the present invention is not impaired.

As the glass substrate in the filter, when being used for an optical filter, it is desirable that reflectance of glass is reduced in order to prevent occurrence of stray light due to reflected light on a glass surface. The reflectance of the glass is determined by a refractive index. Typically, a refractive index at a wavelength of 588 nm is preferably 1.700 to 1.900.

As the glass substrate, when being used in a so-called dual band pass filter having a function of selectively transmitting visible light and specific near-infrared light, the glass substrate is usually used with a thickness of 3 mm or less. From the viewpoint of reducing a weight of the component, the thickness is preferably 2 mm or less, more preferably 1 mm or less, further preferably 0.5 mm or less, and still more preferably 0.3 mm or less. From the viewpoint of ensuring the strength of the glass, the thickness thereof is preferably 0.05 mm or more.

The glass substrate in the filter can be prepared, for example, as follows.

First, raw materials are weighed and mixed so as to fall within the above composition range (mixing step). The raw material mixture is accommodated in a platinum crucible, and heated and melted at a temperature of 1,200° C. to 1,650° C. in an electric furnace (melting step). After being sufficiently stirred and refined, the raw material mixture is cast into a mold, cut and polished to form a flat plate having a predetermined thickness (molding step).

In the melting step of the above manufacturing method, the highest temperature of the glass during glass melting is preferably 1,650° C. or lower. When the highest temperature of the glass during glass melting is equal to or lower than the above temperature, problems such as crystallization of the glass and generation of unmelted foreign matter in the glass are unlikely to occur. The above temperature is more preferably 1,625° C. or lower, and further preferably 1,600° C. or lower.

When the temperature in the melting step is too low, problems such as devitrification occurring during melting and a long time required for burn-through may occur, and thus the temperature is preferably 1,300° C. or higher, and more preferably 1,350° C. or higher.

### <Light-Absorbing Layer>

The filter includes a light-absorbing layer containing a near-infrared ray absorbing dye (NIR dye). Accordingly, it is possible to compensate for a region where light is not shielded due to the reflection characteristics of the dielectric multilayer film by the absorption characteristics that are not affected by the incident angle.

The light-absorbing layer preferably satisfies both the following spectral characteristics (ii-1) and (ii-2). (ii-1) An average transmittance of a light having a wavelength of 450 nm to 600 nm is 70% or more. (ii-2) An average transmittance of a light having a wavelength of 700 nm to 900 nm is 60% or less.

As the near-infrared ray absorbing dye, from the viewpoint of being able to absorb a wide range of light in the near-infrared region while maintaining the transmittance in the visible light region, preferably a combination of two or more kinds of, more preferably three kinds of dyes having different maximum absorption wavelengths and existing in a region of 680 nm to 800 nm may be used. In particular, the near-infrared ray absorbing dye preferably includes a dye having a maximum absorption wavelength at a wavelength of 700 nm or more and less than 730 nm, a dye having a maximum absorption wavelength at a wavelength of 730 nm or more and less than 760 nm, and a dye having a maximum absorption wavelength at a wavelength of 760 nm or more and less than 800 nm.

The NIR dye is preferably at least one selected from the group consisting of a squarylium dye, a cyanine dye, a phthalocyanine dye, a naphthalocyanine dye, a dithiol metal complex dye, an azo dye, a polymethine dye, a phthalide dye, a naphthoquinone dye, an anthraquinone dye, an indophenol dye, a pyrylium dye, a thiopyrylium dye, a croconium dye, a tetradehydrocholine dye, a triphenylmethane dye, an aminium dye, and a diimmonium dye.

The NIR dye preferably contains at least one dye selected from a squarylium dye, a phthalocyanine dye, and a cyanine dye. Among these NIR dyes, a squarylium dye and a cyanine dye are preferable from the viewpoint of spectroscopy, and a phthalocyanine dye is preferable from the viewpoint of durability.

A content of the NIR dye in the light-absorbing layer is preferably 10 mass % or more in order to obtain desired optical characteristics. When the content of the NIR dye is too large, physical properties of the light-absorbing layer are impaired (particularly, glass transition point is lowered), and thus the content is preferably 20 mass % or less, and more preferably 15 mass % or less. In a case where two or more compounds are combined, the above content is a sum of respective compounds.

The light-absorbing layer preferably contains a near-infrared ray absorbing dye and a resin, and the resin is not limited as long as it is a transparent resin, and one or more kinds of transparent resins selected from a polyester resin, an acrylic resin, an epoxy resin, an ene-thiol resin, a polycarbonate resin, a polyether resin, a polyarylate resin, a polysulfone resin, a polyethersulfone resin, a poly(p-phenylene) resin, a polyarylene ether phosphine oxide resin, a polyamide resin, a polyimide resin, a polyamide-imide resin, a polyolefin resin, a cyclic olefin resin, a polyurethane resin, a polystyrene resin, and the like are used. These resins may be used alone, or may be used by mixing two or more kinds thereof.

From the viewpoint of spectral characteristics, glass transition point (Tg), and adhesion of the light-absorbing layer, one or more kinds of resins selected from a polyimide resin, a polycarbonate resin, a polyester resin, and an acrylic resin are preferable.

In a case where a plurality of compounds are used as the NIR dye or other dyes, those compounds may be included in the same light-absorbing layer or may be included in different light-absorbing layers.

The light-absorbing layer can be formed by dissolving or dispersing a dye, a resin or raw material components of the resin, and respective components blended as necessary in a solvent to prepare a coating solution, applying the coating solution to a support, drying the coating solution, and further curing the coating solution as necessary. The support may be a light-absorbing glass substrate or may be a peelable support used only when the light-absorbing layer is formed. In addition, the solvent may be a dispersion medium capable of stably dispersing components or a solvent capable of dissolving components.

In addition, the coating solution may contain a surfactant in order to improve voids due to fine bubbles, depressions due to adhesion of foreign substances and the like, and repelling in a drying process. Further, for the application of the coating solution, for example, a dip coating method, a cast coating method, or a spin coating method can be used. In addition, in a case where the coating solution contains a raw material component of the transparent resin, a curing process such as thermal curing or photocuring is further performed.

The light-absorbing layer can also be manufactured into a film shape by extrusion molding. The filter can be manufactured by laminating the obtained film-shaped absorption layer on the light-absorbing glass substrate and integrating those by thermal press fitting or the like.

The light-absorbing layer may be provided in the optical filter by one layer or two or more layers. In a case where the light-absorbing layer is provided by two or more layers, respective layers may have the same configuration or different configurations.

A thickness of the light-absorbing layer is preferably 5 μm or less from the viewpoint of coating properties, and in-plane film thickness distribution and appearance quality in a substrate after coating, and more preferably 2 μm or less from the viewpoint of reducing an amount of thermal expansion of the resin, and is preferably 0.5 μm or more from the viewpoint of exhibiting desired spectral characteristics at an appropriate dye concentration. In a case where the optical filter has two or more layers of light-absorbing layers, a total thickness of the respective light-absorbing layers is preferably within the above range.

### <Dielectric Multilayer Film>

The filter includes the dielectric multilayer film 1 on a surface of the light-absorbing layer, and the dielectric multilayer film 2 on or above one main surface of the glass substrate. The larger a thickness of the dielectric multilayer film, the easier to control the spectral characteristics. On the other hand, when the thickness is too large, a stress is likely to be generated, which may cause deformation. By providing the dielectric multilayer films at two positions, it is possible to disperse the role in controlling the spectral characteristics and avoid the thickness from being concentrated on one of the multilayer films.

Both the dielectric multilayer films 1 and 2 are preferably designed as reflective films (hereinafter, also referred to as “NIR reflective films”) that reflect a part of near-infrared light. The NIR reflection films may be further appropriately designed to have a specification further reflecting light in a wavelength range other than the near-infrared light, for example, near ultraviolet light.

The dielectric multilayer film 1 preferably satisfies all of the following spectral characteristics (iii-1-1) to (iii-1-3). (iii-1-1) An average reflectance of a light having a wavelength of 450 nm to 600 nm at an incident angle of 5 degrees is 2.0% or less. (iii-1-2) An average reflectance of a light having a wavelength of 430 nm to 700 nm at an incident angle of 5 degrees is 2.5% or less. (iii-1-3) An average reflectance of a light having a wavelength of 1,110 nm to 1,200 nm at an incident angle of 5 degrees is 5.0% or less.

Satisfying the above characteristics is particularly preferable because an optical filter that satisfies the spectral characteristics (i-1) and (i-3) is easily obtained.

The dielectric multilayer film 2 preferably satisfies all of the following spectral characteristics (iii-2-1) to (iii-2-3). (iii-2-1) The average reflectance of the light having a wavelength of 450 nm to 600 nm at an incident angle of 5 degrees is 2.0% or less. (iii-2-2) The average reflectance of the light having a wavelength of 430 nm to 700 nm at an incident angle of 5 degrees is 2.5% or less. (iii-2-3) The average reflectance of the light having a wavelength of 1,110 nm to 1,200 nm at an incident angle of 5 degrees is 5.0% or less.

Satisfying the above characteristics is particularly preferable because an optical filter that satisfies the spectral characteristics (i-1) and (i-3) is easily obtained.

In the dielectric multilayer film 2, it is preferable that an absolute value of the difference between the wavelength at which the reflectance of light at an incident angle of 5 degrees is 25% and the wavelength at which the reflectance is 85% in a wavelength of 550 nm to 850 nm be 20 nm or less.

This is preferable because an optical filter satisfying the spectral characteristic (i-6) can be easily obtained.

The filter preferably includes the dielectric multilayer film 3 between the light-absorbing layer and the glass substrate. By the three dielectric multilayer films, the spectral characteristics can be more flexibly controlled and an effect of relaxing an interference waveform generated in the light-absorbing layer can be expected.

The dielectric multilayer film is a laminate of dielectric films having different refractive indices. More specifically, examples of the dielectric films include a dielectric film having a low refractive index (low refractive index film), a dielectric film having a medium refractive index (medium refractive index film), and a dielectric film having a high refractive index (high refractive index film), and the laminate is composed of a dielectric multilayer film in which two or more of those dielectric films are laminated. The reflection characteristics can be adjusted by combining several types of dielectric films having different spectral characteristics when transmitting and selecting a desired wavelength band.

A refractive index of a high refractive index material at a wavelength of 500 nm is preferably 1.8 or more and 2.5 or less, and more preferably 1.9 or more and 2.5 or less. Examples of the high refractive index material include Ta₂O₅, TiO₂, TiO, and Nb₂O₅. Other commercially available products thereof include OS50 (Ti₃O₅), OS10 (Ti₄O₇), OA500 (a mixture of Ta₂O₅ and ZrO₂), and OA600 (a mixture of Ta₂O₅ and TiO₂) manufactured by Canon Optron, Inc. Among those, TiO₂ is preferable from the viewpoint of reproducibility in film formability and refractive index, stability, and the like.

A refractive index of a medium refractive index material at a wavelength of 500 nm is preferably more than 1.5 and less than 1.8, and more preferably 1.55 or more and less than 1.8. Examples of the medium refractive index material include ZrO₂, Nb₂O₅, Al₂O₃, HfO₂, OM-4 and OM-6 (mixtures of Al₂O₃ and ZrO₂) sold by Canon Optron, Inc., OA-100, and H4 and M2 (alumina lanthania) sold by Merck KGaA. Among those, Al₂O₃-based compounds and mixtures of Al₂O₃ and ZrO₂ are preferable from the viewpoint of reproducibility in film formability and refractive index, stability, and the like. The medium refractive index film may be replaced with an equivalent film including a high refractive index film and a low refractive index film without using the medium refractive index material described above.

A refractive index of a low refractive index material at a wavelength of 500 nm is preferably 1.4 or more and 1.5 or less, and more preferably 1.45 or more and 1.5 or less. Examples of the low refractive index material include SiO₂, SiOₓN_{y}, and MgF₂. Other commercially available products thereof include S4F and S5F (mixtures of SiO₂ and Al₂O₃) manufactured by Canon Optron, Inc. Among those, SiO₂ is preferable from the viewpoint of reproducibility in film formability, stability, economic efficiency, and the like.

A film thickness (physical film thickness) of the dielectric multilayer film 1 is preferably 1,500 nm or more and more preferably 2,000 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 1 is preferably 100 or less, more preferably 80 or less, and still more preferably 70 or less, from the viewpoint of productivity and viability.

A film thickness (physical film thickness) of the dielectric multilayer film 2 is preferably 1,500 nm or more and more preferably 2,000 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 2 is preferably 100 or less, more preferably 80 or less, and still more preferably 70 or less, from the viewpoint of productivity and viability.

A film thickness (physical film thickness) of the dielectric multilayer film 3 is preferably 150 nm or more and more preferably 200 nm or more from the viewpoint of easily controlling the spectral characteristics, and is preferably 6,000 nm or less from the viewpoint of productivity and prevention of a reflection ripple in the visible light region.

The total number of laminated layers of the dielectric multilayer film 3 is preferably 100 or less, more preferably 50 or less, and still more preferably 25 or less, from the viewpoint of productivity and viability.

For formation of the dielectric multilayer film, for example, a vacuum film formation process such as a CVD method, a sputtering method, or a vacuum deposition method, a wet film formation process such as a spraying method or a dipping method, or the like can be used.

The filter may include, as another component, for example, a component (layer) that provides absorption by inorganic fine particles or the like that control transmission and absorption of light in a specific wavelength region. Specific examples of the inorganic fine particles include indium tin oxides (ITO), antimony-doped tin oxides (ATO), cesium tungstate, and lanthanum boride. The ITO fine particles and the cesium tungstate fine particles have high visible light transmittance and have light absorbing properties in a wide range of an infrared wavelength region exceeding 1,200 nm, and thus can be used in a case where shielding properties of infrared light are required.

### <Imaging Device>

The imaging device according to the present invention preferably includes the optical filter according to the present invention described above. The imaging device preferably further includes a solid state image sensor and an imaging lens. The optical filter according to the present embodiment can be used, for example, by being disposed between the imaging lens and the solid state image sensor, or by being directly attached to the solid state image sensor, the imaging lens, or the like of the imaging device via an adhesive layer. By providing the filter which is excellent in transmittance of visible light and specific near-infrared light, has shielding properties of specific near-infrared light, and has a spectral curve hardly shifted even at a high incident angle, it is possible to obtain an imaging device excellent in color reproducibility even for light at a high incident angle.

When the optical filter is to be mounted on the imaging device, it is generally preferable that the dielectric multilayer film 2 (substrate side) be on a lens side and the dielectric multilayer film 1 (light-absorbing layer side) be on a sensor side.

As described above, the present description discloses the following optical filters and the like.

[1] An optical filter including a dielectric multilayer film 1, a light-absorbing layer, a glass substrate, and a dielectric multilayer film 2 in this order, in which
the light-absorbing layer contains a near-infrared ray absorbing dye, and
the optical filter satisfies all of the following spectral characteristics (i-1) to (i-6):
(i-1) an average transmittance of a light having a wavelength of 450 nm to 600 nm at an incident angle of 0 degrees is 85% or more,
(i-2) an absolute value of a difference between a wavelength at which a transmittance of a light having a wavelength of 550 nm to 750 nm is 50% at an incident angle of 0 degrees and a wavelength at which a transmittance of a light having a wavelength of 550 nm to 750 nm is 50% at an incident angle of 30 degrees is 10 nm or less,
(i-3) an average transmittance of a light having a wavelength of 725 nm to 1,000 nm at an incident angle of 0 degrees is 1% or less,
(i-4) a wavelength IR50 at which a transmittance of a light at an incident angle of 0 degrees is 50% is in a range of 1,000 nm to 1,150 nm,
(i-5) an average transmittance of a light having a wavelength of 1,100 nm to 1,200 nm at an incident angle of 0 degrees is 80% or more, and
(i-6) an absolute value of a difference between a wavelength at which a reflectance of a light at an incident angle of 5 degrees is 25% and a wavelength at which the reflectance is 85% in a wavelength of 550 nm to 850 nm is 20 nm or less when the light is incident from at least one main surface of the optical filter.

[2] The optical filter according to [1], in which the optical filter further satisfies the following spectral characteristic (i-7):
(i-7) an absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.

[3] The optical filter according to [1] or [2], in which in the spectral characteristic (i-5), the average transmittance of the light having a wavelength of 1,100 nm to 1,200 nm at an incident angle of 0 degrees is 85% or more.

[4] The optical filter according to any of [1] to [3], in which the optical filter satisfies the following spectral characteristic (i-8):
(i-8) an absolute value of a difference between an average transmittance of a light having a wavelength of 1,100 nm to 1,200 nm at an incident angle of 0 degrees and an average transmittance of the light having a wavelength of 1,100 nm to 1,200 nm at an incident angle of 30 degrees is 6% or less.

[5] The optical filter according to any of [1] to [4], in which the optical filter satisfies the following spectral characteristic (i-9):
(i-9) a wavelength at which an absorption loss amount of a light is 30% is in a range of 600 nm to 750 nm and in a range of 800 nm to 1,200 nm,
where, when a light is incident from either of the main surfaces, an (absorption loss amount)_{X} at a wavelength of X nm is defined as follows:
(absorption loss amount)_{X} [%]=100−(transmittance at incident angle of 0 degrees)−(reflectance at incident angle of 5 degrees).

[6] The optical filter according to any of [1] to [5], in which the dielectric multilayer film 1 has a thickness of 1,500 nm or more.

[7] The optical filter according to any of [1] to [6], further including a dielectric multilayer film 3 between the light-absorbing layer and the glass substrate.

[8] The optical filter according to any of [1] to [7], in which the glass substrate is an ytterbium-containing glass substrate.

[9] The optical filter according to any of [1] to [8], in which the optical filter satisfies the following spectral characteristic (i-10):
(i-10) an absolute value of a difference between a wavelength at which a transmittance of a light having a wavelength of 950 nm to 1,150 nm is 50% at an incident angle of 0 degrees and a wavelength at which a transmittance of the light having a wavelength of 950 nm to 1,150 nm is 50% at an incident angle of 30 degrees is 70 nm or less.

[10] The optical filter according to any of [1] to [9], in which the near-infrared ray absorbing dye in the light-absorbing layer includes a dye having a maximum absorption wavelength at a wavelength of 700 nm or more and less than 730 nm, a dye having a maximum absorption wavelength at a wavelength of 730 nm or more and less than 760 nm, and a dye having a maximum absorption wavelength at a wavelength of 760 nm or more and less than 800 nm.

[11] An imaging device including the optical filter according to any of [1] to [10].

### EXAMPLES

Next, the present invention will be described more specifically with reference to examples.

For measurement of each spectral characteristic, an ultraviolet-visible spectrophotometer (UH-4150 type, manufactured by Hitachi High-Tech Corporation) was used.

The spectral characteristic in a case where an incident angle is not particularly specified is a value measured at an incident angle of 0 degrees (in a direction perpendicular to a main surface of an optical filter).

Dyes used in respective examples are as follows.

Compound 1 (squarylium compound): synthesized based on U.S. Pat. No. 5,543,086. Compound 2 (squarylium compound): synthesized based on WO2017/135359. Compound 3 (merocyanine compound): synthesized based on the description of German Patent No. 10109243. Compound 4 (cyanine compound): synthesized based on Dyes and pigments 73 (2007) 344-352.

Compound 5 (cyanine compound): synthesized based on Dyes and pigments 73 (2007) 344-352.

The compound 1, the compound 2, the compound 4, and the compound 5 are near-infrared ray absorbing dyes (NIR dyes), and the compound 3 is a near ultraviolet absorbing dye (UV dye).

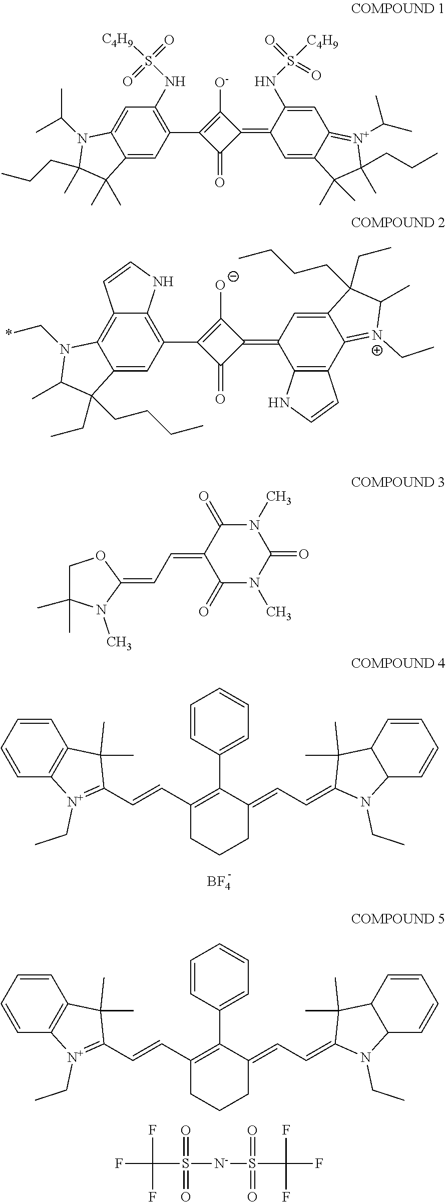

### <Spectral Characteristics of Dye>

Maximum absorption wavelengths in absorption spectrums measured after dissolving the above dyes (compounds 1 to 5) in dichloromethane are shown in Table 1 below.

### <Glass Substrate>

As the glass substrate, a glass A which is a light-absorbing glass, and a non-absorbing glass B were prepared.

As the glass A, raw materials including, in terms of mol % based on an oxide, 7.5% of SiO₂, 23.6% of B₂O₃, 7.5% of P₂O₅, 47.2% of Yb₂O₃, 11.8% of Ga₂O₃, and 2.4% of La₂O₃ were weighed and mixed, placed in a crucible having an internal volume of about 400 cc, and melted at 1,400° C. to 1,650° C. for 2 hours in an air atmosphere. Thereafter, the mixture was clarified, stirred, cast into a rectangular mold having a length of 100 mm, a width of 50 mm, and a height of 20 mm that was preheated to about 300° C. to 500° C., slowly cooled to room temperature at about −1° C./min, cut to have a predetermined thickness within a range of a length of 40 mm, a width of 30 mm, and a thickness of 0.3 mm to 1.5 mm, and optically polished on both sides to obtain a plate-shaped glass.

In addition, the glass B is a non-absorbing glass, and a D263 glass (borosilicate glass, commercially available product, manufactured by Schott) was used.

The following raw materials were used for each glass.
SiO₂: oxide
B₂O₃: one or more selected from oxide, PBO₄, and H₃BO₃
P₂O₅: one or more of H₃PO₄ and PBO₄
GeO₂: oxide
ZrO₂: oxide
Ga₂O₃: oxide
Yb₂O₃: oxide
La₂O₃: oxide
Al₂O₃: one or more of oxide and Al(OH)₃

The raw materials of the glass are not limited to the above, and known raw materials can be used.

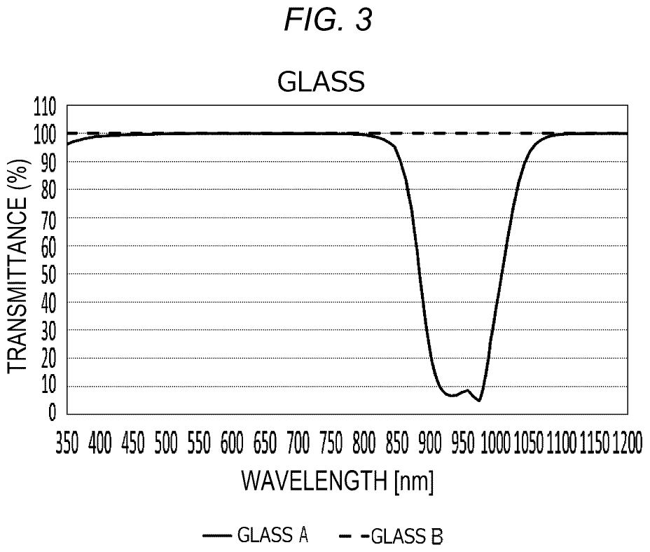

Transmittance curves for light having a wavelength of 350 nm to 1,200 nm of the glass A and the glass B (sheet thickness of both glass A and glass B: 0.4 mm, internal transmittance) are illustrated in FIG. 3.

### <Light-Absorbing Layer>

Any of the dyes of the compounds 1 to 5 was dissolved in a polyimide resin (C-3G30G, manufactured by Mitsubishi Gas Chemical Company, Inc.), mixed at a concentration shown in the following table, and stirred and dissolved at 50° C. for 2 hours to obtain a coating solution.

The obtained coating solution was applied onto an alkali glass (D263 glass, thickness: 0.2 mm, manufactured by SCHOTT) by a spin coating method to form a light-absorbing layer having a film thickness shown in the following Table 1.

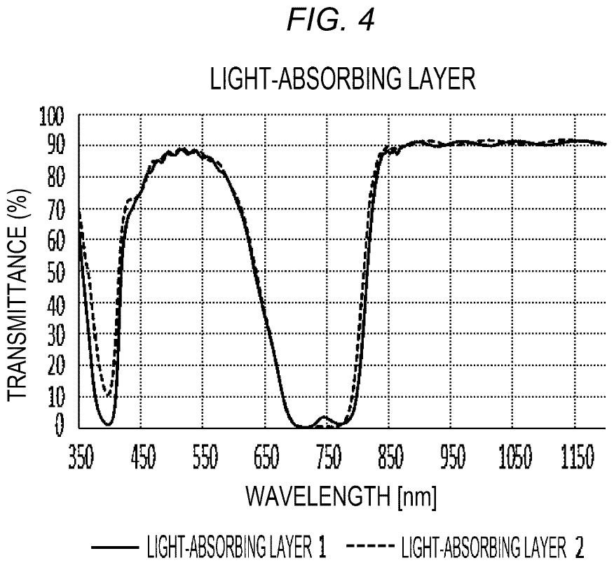

In addition, transmittance curves for the light having a wavelength of 350 nm to 1,200 nm of the light-absorbing layers are illustrated in FIG. 4.

TABLE 1

| | | Light- | Light- |
|---|---|---|---|
| | | absorbing | absorbing |
| | | layer 1 | layer 2 |
| Resin | | Polyimide | Polyimide |
| Added | Compound 1 (λMAX: 773 nm) | — | 2.8 |
| amount | Compound 2 (λMAX: 752 nm) | — | 4.0 |
| of dye | Compound 3 (λMAX: 397 nm) | 4.9 | 2.9 |
| (mass %) | Compound 4 (λMAX: 713 nm) | 4.1 | 4.7 |
| | Compound 5 (λMAX: 772 nm) | 5.6 | — |
| | Total | 14.6 | 14.5 |

| | | |
|---|---|---|
| Film thickness (μm) | 1.4 | 1.1 |

### Example 1: Optical Filter

A dielectric multilayer film 2A was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1A was formed by alternately laminating SiO₂ and TiO₂ on a surface of the light-absorbing layer by vapor deposition.

Thus, an optical filter of Example 1 was manufactured.

### Example 2

An optical filter of Example 2 was manufactured in the same manner as in Example 1 except that a light-absorbing glass A was used instead of the glass B as the glass substrate and a dielectric multilayer film 1B was used instead of the dielectric multilayer film 1A.

### Example 3

An optical filter of Example 3 was manufactured in the same manner as in Example 1 except that a dielectric multilayer film 3A was formed by alternately laminating SiO₂ and TiO₂ between the glass substrate and the light-absorbing layer by vapor deposition.

### Example 4

An optical filter of Example 4 was manufactured in the same manner as in Example 2 except that a dielectric multilayer film 3A was formed by alternately laminating SiO₂ and TiO₂ between the glass substrate and the light-absorbing layer by vapor deposition.

### Example 5

A dielectric multilayer film 2B was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 2, and an organic solvent was removed by sufficiently heating, thereby forming a light-absorbing layer.

A dielectric multilayer film 1C was formed by alternately laminating SiO₂ and TiO₂ on a surface of the light-absorbing layer by vapor deposition.

Thus, an optical filter of Example 5 was manufactured.

### Example 6

A dielectric multilayer film 2C was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1D was formed by alternately laminating SiO₂ and TiO₂ on a surface of the light-absorbing layer by vapor deposition.

Thus, an optical filter of Example 6 was manufactured.

### Example 7

A dielectric multilayer film 2D was formed by alternately laminating SiO₂ and TiO₂ on one main surface of the glass substrate (glass B having no light absorbing property) by vapor deposition.

A resin solution was applied to the other main surface of the glass substrate with the same composition as that of the light-absorbing layer 1, and an organic solvent was removed by sufficiently heating, thereby forming a light-absorbing layer.

A dielectric multilayer film 1E was formed by alternately laminating SiO₂ and TiO₂ on a surface of the light-absorbing layer by vapor deposition.

Thus, an optical filter of Example 7 was manufactured.

### Example 8

A dielectric multilayer film 2E was formed by alternately laminating SiO₂ and TiO₂ on one main surface of the glass substrate (glass B having no light absorbing property) by vapor deposition.

A dielectric multilayer film 1F was formed by alternately laminating SiO₂ and TiO₂ on the other main surface of the glass substrate by vapor deposition.

Thus, an optical filter of Example 8 was manufactured.

### Example 9

An optical filter of Example 9 was manufactured in the same manner as in Example 8 except that a light-absorbing layer having the same composition as the light-absorbing layer 1 was formed between the glass substrate and the dielectric multilayer film 1.

Configurations of the dielectric multilayer films 1A, 1B, 2A, and 3A are shown in the following Tables 2 to 4, respectively. An order of the numbers (No.) corresponds to a lamination order.

TABLE 2

| Type of multilayer film: 1A | | | | | | Type of multilayer film: 1B | | |
|---|---|---|---|---|---|---|---|---|
| | Film | Physical film thickness | | Film | Physical film thickness | | Film | Physical film thickness |
| No. | material | [nm] | No. | material | [nm] | No. | material | [nm] |
| Air side | | | 28 | SiO₂ | 163.07 | Air side | | |
| 56 | SiO₂ | 100.02 | 27 | TiO₂ | 87.17 | 40 | SiO₂ | 83.17 |
| 55 | TiO₂ | 22.12 | 26 | SiO₂ | 157.98 | 39 | TiO₂ | 94.18 |
| 54 | SiO₂ | 26.42 | 25 | TiO₂ | 91.17 | 38 | SiO₂ | 12.00 |
| 53 | TiO₂ | 12.02 | 24 | SiO₂ | 161.12 | 37 | TiO₂ | 23.80 |
| 52 | SiO₂ | 175.12 | 23 | TiO₂ | 99.63 | 36 | SiO₂ | 21.45 |
| 51 | TiO₂ | 112.59 | 22 | SiO₂ | 176.92 | 35 | TiO₂ | 93.20 |
| 50 | SiO₂ | 31.76 | 21 | TiO₂ | 105.13 | 34 | SiO₂ | 12.00 |
| 49 | TiO₂ | 23.62 | 20 | SiO₂ | 174.38 | 33 | TiO₂ | 12.00 |
| 48 | SiO₂ | 12.00 | 19 | TiO₂ | 100.28 | 32 | SiO₂ | 126.91 |
| 47 | TiO₂ | 95.41 | 18 | SiO₂ | 167.67 | 31 | TiO₂ | 12.00 |
| 46 | SiO₂ | 176.99 | 17 | TiO₂ | 95.95 | 30 | SiO₂ | 15.33 |
| 45 | TiO₂ | 145.89 | 16 | SiO₂ | 170.90 | 29 | TiO₂ | 73.38 |
| 44 | SiO₂ | 12.62 | 15 | TiO₂ | 44.43 | 28 | SiO₂ | 163.41 |
| 43 | TiO₂ | 35.29 | 14 | SiO₂ | 12.00 | 27 | TiO₂ | 82.26 |
| 42 | SiO₂ | 181.90 | 13 | TiO₂ | 33.74 | 26 | SiO₂ | 36.81 |
| 41 | TiO₂ | 93.00 | 12 | SiO₂ | 158.05 | 25 | TiO₂ | 12.00 |
| 40 | SiO₂ | 152.33 | 11 | TiO₂ | 12.00 | 24 | SiO₂ | 74.65 |
| 39 | TiO₂ | 88.65 | 10 | SiO₂ | 12.00 | 23 | TiO₂ | 98.66 |
| 38 | SiO₂ | 152.53 | 9 | TiO₂ | 65.31 | 22 | SiO₂ | 135.21 |
| 37 | TiO₂ | 87.50 | 8 | SiO₂ | 12.33 | 21 | TiO₂ | 12.00 |
| 36 | SiO₂ | 155.77 | 7 | TiO₂ | 12.00 | 20 | SiO₂ | 14.05 |
| 35 | TiO₂ | 94.00 | 6 | SiO₂ | 156.63 | 19 | TiO₂ | 69.85 |
| 34 | SiO₂ | 213.52 | 5 | TiO₂ | 25.35 | 18 | SiO₂ | 162.21 |
| 33 | TiO₂ | 12.00 | 4 | SiO₂ | 13.25 | 17 | TiO₂ | 83.82 |
| 32 | SiO₂ | 61.71 | 3 | TiO₂ | 53.30 | 16 | SiO₂ | 32.33 |
| 31 | TiO₂ | 19.78 | 2 | SiO₂ | 31.24 | 15 | TiO₂ | 12.00 |
| 30 | SiO₂ | 12.00 | 1 | TiO₂ | 14.04 | 14 | SiO₂ | 63.90 |

| | | | | | | |
|---|---|---|---|---|---|---|
| 29 | TiO₂ | 86.82 | Light-absorbing layer side | 13 | TiO₂ | 12.00 |

| | | |
|---|---|---|
| 12 | SiO₂ | 12.00 |
| 11 | TiO₂ | 90.12 |
| 10 | SiO₂ | 57.37 |
| 9 | TiO₂ | 12.00 |
| 8 | SiO₂ | 58.29 |
| 7 | TiO₂ | 115.99 |
| 6 | SiO₂ | 31.82 |
| 5 | TiO₂ | 31.91 |
| 4 | SiO₂ | 16.35 |
| 3 | TiO₂ | 82.18 |
| 2 | SiO₂ | 29.41 |
| 1 | TiO₂ | 16.69 |

Light-absorbing layer side

TABLE 3
Type of multilayer film: 2A

| | | |
|---|---|---|
| | | Physical film |
| No. | Film material | thickness [nm] |

Substrate side

| | | |
|---|---|---|
| 1 | TiO₂ | 19.42 |
| 2 | SiO₂ | 20.70 |
| 3 | TiO₂ | 134.69 |
| 4 | SiO₂ | 34.67 |
| 5 | TiO₂ | 16.59 |
| 6 | SiO₂ | 263.74 |
| 7 | TiO₂ | 16.08 |
| 8 | SiO₂ | 34.91 |
| 9 | TiO₂ | 88.57 |
| 10 | SiO₂ | 17.52 |
| 11 | TiO₂ | 21.56 |
| 12 | SiO₂ | 238.65 |
| 13 | TiO₂ | 17.37 |
| 14 | SiO₂ | 39.27 |
| 15 | TiO₂ | 108.37 |
| 16 | SiO₂ | 16.71 |
| 17 | TiO₂ | 15.44 |
| 18 | SiO₂ | 222.63 |
| 19 | TiO₂ | 18.94 |
| 20 | SiO₂ | 38.53 |
| 21 | TiO₂ | 111.97 |
| 22 | SiO₂ | 13.20 |
| 23 | TiO₂ | 13.51 |
| 24 | SiO₂ | 210.54 |
| 25 | TiO₂ | 22.18 |
| 26 | SiO₂ | 33.28 |
| 27 | TiO₂ | 110.05 |
| 28 | SiO₂ | 11.75 |
| 29 | TiO₂ | 18.43 |
| 30 | SiO₂ | 211.05 |
| 31 | TiO₂ | 23.84 |
| 32 | SiO₂ | 31.79 |
| 33 | TiO₂ | 128.40 |
| 34 | SiO₂ | 24.90 |
| 35 | TiO₂ | 9.00 |
| 36 | SiO₂ | 173.65 |
| 37 | TiO₂ | 22.06 |
| 38 | SiO₂ | 21.25 |
| 39 | TiO₂ | 128.14 |
| 40 | SiO₂ | 21.15 |
| 41 | TiO₂ | 22.18 |
| 42 | SiO₂ | 216.06 |
| 43 | TiO₂ | 27.91 |
| 44 | SiO₂ | 26.60 |
| 45 | TiO₂ | 62.35 |
| 46 | SiO₂ | 31.38 |
| 47 | TiO₂ | 24.51 |
| 48 | SiO₂ | 242.12 |
| 49 | TiO₂ | 21.12 |
| 50 | SiO₂ | 31.35 |
| 51 | TiO₂ | 100.44 |
| 52 | SiO₂ | 15.03 |
| 53 | TiO₂ | 22.54 |
| 54 | SiO₂ | 228.19 |
| 55 | TiO₂ | 19.49 |
| 56 | SiO₂ | 58.65 |
| 57 | TiO₂ | 30.47 |
| 58 | SiO₂ | 49.03 |
| 59 | TiO₂ | 26.72 |
| 60 | SiO₂ | 115.44 |

Air side

TABLE 4
Type of multilayer film: 3A

| | | |
|---|---|---|
| | Film | Physical film |
| No. | material | thickness [nm] |

Light-absorbing layer side

| | | |
|---|---|---|
| 11 | TiO₂ | 17.36 |
| 10 | SiO₂ | 35.02 |
| 9 | TiO₂ | 140.56 |
| 8 | SiO₂ | 19.91 |
| 7 | TiO₂ | 49.40 |
| 6 | SiO₂ | 12.00 |
| 5 | TiO₂ | 71.16 |
| 4 | SiO₂ | 12.00 |
| 3 | TiO₂ | 143.76 |
| 2 | SiO₂ | 31.17 |
| 1 | TiO₂ | 18.36 |

Substrate side

With respect to the respective optical filters obtained as described above, spectral transmittance curves at an incident angle of 0 degrees and an incident angle of 30 degrees, and spectral reflectance curves at an incident angle of 5 degrees and an incident angle of 30 degrees in a wavelength range of 350 nm to 1,200 nm were measured using an ultraviolet-visible spectrophotometer.

Respective characteristics shown in the following Table 5 were calculated based on the obtained data of the spectral characteristics.

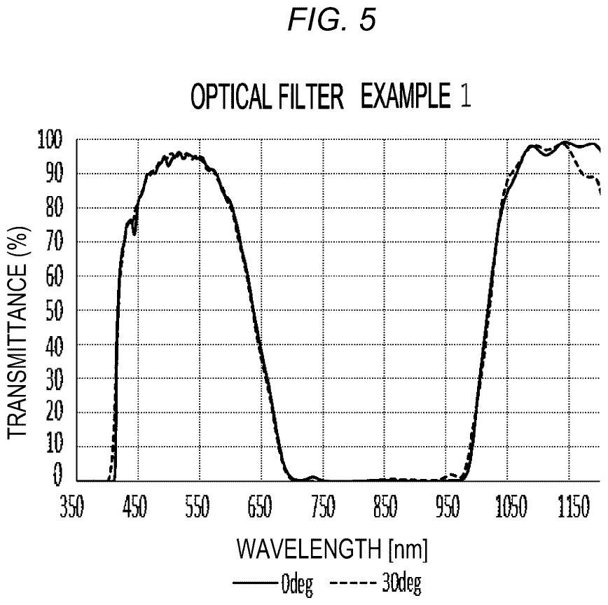

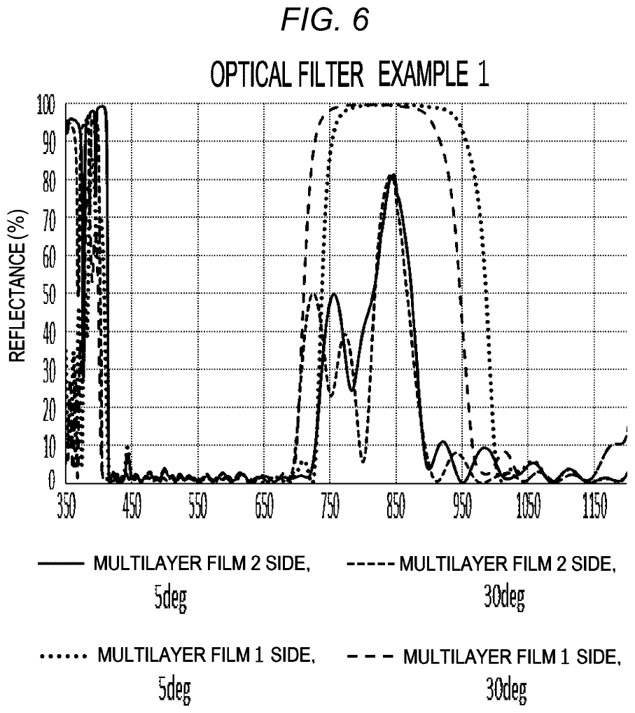

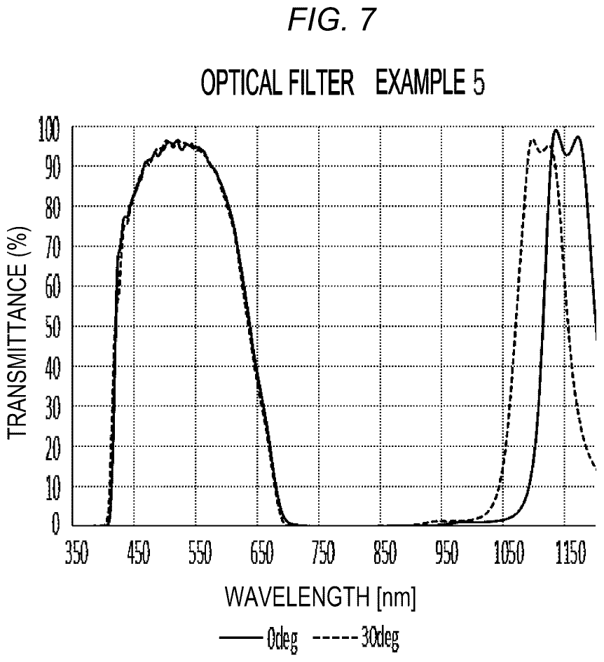

Further, spectral transmittance curves and spectral reflectance curves of the optical filter of Example 1 are illustrated in FIGS. 5 to 6, and spectral transmittance curves of the optical filter of Example 5 are illustrated in FIG. 7, respectively.

Examples 1 to 4 are inventive examples, and Examples 5 to 9 are comparative examples.

TABLE 5

| | | Example | Example | Example | Example | Example | Example | Example | Example | Example |
|---|---|---|---|---|---|---|---|---|---|---|
| Optical filter | | 1 | 2 | 3 | 4 | 5 | 6 | 7 | 8 | 9 |
| Dielectric | Type of | 1A | 1B | 1A | 1B | 1C | 1D | 1E | 1F | 1F |
| multilayer | multilayer film | | | | | | | | | |
| film 1 | Film material | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ |
| | Number of | 56 | 40 | 56 | 40 | 8 | 16 | 40 | 38 | 38 |
| | laminated layers | | | | | | | | | |
| | Physical film | 4,800.42 | 2,198.71 | 4,800.42 | 2,198.71 | 346.43 | 1,999.36 | 2,838.5 | 2,920.95 | 2,920.95 |
| | thickness [nm] | | | | | | | | | |
| Light- | Type of light- | 1 | 1 | 1 | 1 | 2 | 1 | 1 | — | 1 |
| absorbing | absorbing layer | | | | | | | | | |
| layer | Type of resin | Polyimide | Polyimide | Polyimide | Polyimide | Polyimide | Polyimide | Polyimide | | Polyimide |
| | Dye | 3 types | 3 types | 3 types | 3 types | 4 types | 3 types | 3 types | | 3 types |
| | Physical film | 1.4 | 1.4 | 1.4 | 1.4 | 1.1 | 1.4 | 1.4 | | 1.4 |
| | thickness [μm] | | | | | | | | | |
| Dielectric | Type of | — | — | 3A | 3A | — | — | — | — | — |
| multilayer | multilayer film | | | | | | | | | |
| film 3 | Film material | | | TiO₂/SiO₂ | TiO₂/SiO₂ | | | | | |
| | Number of | | | 11 | 11 | | | | | |
| | laminated layers | | | | | | | | | |
| | Physical film | | | 550.7 | 550.7 | | | | | |
| | thickness [nm] | | | | | | | | | |
| Glass | Type | Glass B | Glass A | Glass B | Glass A | Glass B | Glass B | Glass B | Glass B | Glass B |
| substrate | Sheet thickness | 0.30 | 0.56 | 0.30 | 0.56 | 0.30 | 0.30 | 0.30 | 0.30 | 0.30 |
| | [mm] | | | | | | | | | |
| Dielectric | Type of | 2A | 2A | 2A | 2A | 2B | 2C | 2D | 2E | 2E |
| multilayer | multilayer film | | | | | | | | | |
| film 2 | Film material | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ | TiO₂/SiO₂ |
| | Number of | 60 | 60 | 60 | 60 | 52 | 60 | 48 | 44 | 44 |
| | laminated layers | | | | | | | | | |
| | Physical film | 4,096.08 | 4,096.08 | 4,096.08 | 4,096.08 | 4,261.96 | 3,127.91 | 2,896.41 | 2,978.45 | 2,978.45 |
| | thickness [nm] | | | | | | | | | |

TABLE 6

| | | Example | Example | Example | Example | Example | Example | Example | Example | Example |
|---|---|---|---|---|---|---|---|---|---|---|
| | | 1 | 2 | 3 | 4 | 5 | 6 | 7 | 8 | 9 |
| Optical filter | Average transmittance of | 88.87 | 91.35 | 88.51 | 90.87 | 91.38 | 90.57 | 91.99 | 98.74 | 91.88 |
| spectral | light of 450 nm to 600 | | | | | | | | | |
| characteristics | nm at incident angle of | | | | | | | | | |
| | 0 degrees [%] | | | | | | | | | |
| | Absolute value of | 1 | 2 | 1 | 1 | 1 | 3 | 2 | 26 | 2 |
| | difference between | | | | | | | | | |
| | wavelength at which | | | | | | | | | |
| | transmittance of light | | | | | | | | | |
| | having wavelength of | | | | | | | | | |
| | 550 nm to 750 nm is | | | | | | | | | |
| | 50% at incident angle | | | | | | | | | |
| | of 0 degrees and | | | | | | | | | |
| | wavelength at which | | | | | | | | | |
| | transmittance of | | | | | | | | | |
| | light having wavelength | | | | | | | | | |
| | of 550 nm to 750 nm | | | | | | | | | |
| | is 50% at incident | | | | | | | | | |
| | angle of 30 degrees | | | | | | | | | |
| | [nm] | | | | | | | | | |
| | Average transmittance | 0.22 | 0.86 | 0.24 | 0.83 | 47.10 | 36.15 | 5.06 | 0.72 | 0.22 |
| | of light of 725 nm | | | | | | | | | |
| | to 1,000 nm at incident | | | | | | | | | |
| | angle of 0 | | | | | | | | | |
| | degrees [%] | | | | | | | | | |
| | Wavelength IR50 | 1,111.00 | 1,018.00 | 1,112.00 | 1,018.00 | 808.00 | 903.00 | 989.00 | 1,114.00 | 1,114.00 |
| | at incident angle | | | | | | | | | |
| | of 0 degrees | | | | | | | | | |
| | [nm] | | | | | | | | | |
| | Average transmittance | 85.72 | 97.82 | 85.11 | 94.39 | 0.53 | 0.23 | 11.04 | 78.61 | 78.35 |
| | of light of 1,100 nm | | | | | | | | | |
| | to 1,200 nm at incident | | | | | | | | | |
| | angle of 0 degrees | | | | | | | | | |
| | [%] | | | | | | | | | |
| | Absolute value of | 15 | 13 | 15 | 13 | 8 | 25 | 104 | 9 | 43 |
| | difference between | | | | | | | | | |
| | wavelength at which | | | | | | | | | |
| | reflectance of | | | | | | | | | |
| | light having | | | | | | | | | |
| | wavelength of 550 nm | | | | | | | | | |
| | to 850 nm is 25% at | | | | | | | | | |
| | incident angle of 5 | | | | | | | | | |
| | degrees and wavelength | | | | | | | | | |
| | at which reflectance | | | | | | | | | |
| | is 85% [nm] | | | | | | | | | |
| | Absolute value of | 474 | 380 | 476 | 382 | 168 | 265 | 352 | 396 | 476 |
| | difference between | | | | | | | | | |
| | wavelength at which | | | | | | | | | |
| | transmittance of light | | | | | | | | | |
| | having wavelength of | | | | | | | | | |
| | 550 nm to 750 nm is | | | | | | | | | |
| | 50% at incident angle | | | | | | | | | |
| | of 0 degrees and | | | | | | | | | |
| | wavelength at which | | | | | | | | | |
| | transmittance of light | | | | | | | | | |
| | having wavelength of | | | | | | | | | |
| | 950 nm to 1,150 nm | | | | | | | | | |
| | is 50% at incident | | | | | | | | | |
| | angle of 0 degrees | | | | | | | | | |
| | [nm] | | | | | | | | | |
| | Absolute value of | 4.59 | 3.58 | 0.13 | 5.08 | 0.84 | 0.22 | 8.05 | 19.61 | 19.4 |
| | difference between | | | | | | | | | |
| | average transmittance | | | | | | | | | |
| | of light of 1,100 nm | | | | | | | | | |
| | to 1,200 nm at incident | | | | | | | | | |
| | angle of 0 degrees and | | | | | | | | | |
| | average transmittance | | | | | | | | | |
| | of light of 1,100 nm | | | | | | | | | |
| | to 1,200 nm at incident | | | | | | | | | |
| | angle of 30 degrees | | | | | | | | | |
| | [%] | | | | | | | | | |
| | Wavelength at | 619 | 619 | 620 | 619 | 620 | 618 | 618 | — | 619 |
| | which absorption | 827 | 1,031 | 824 | 1,031 | 815 | 825 | 723 | — | 721 |
| | loss amount of light | | | | | | | | | |
| | is 30% [nm] | | | | | | | | | |
| | Absolute value of | 52 | 55 | 52 | 55 | 36 | 42 | 40 | 46 | 46 |
| | difference between | | | | | | | | | |
| | wavelength at | | | | | | | | | |
| | which transmittance | | | | | | | | | |
| | of light having | | | | | | | | | |
| | wavelength of 950 | | | | | | | | | |
| | nm to 1,150 nm is 50% | | | | | | | | | |
| | at incident angle | | | | | | | | | |
| | of 0 degrees and | | | | | | | | | |
| | wavelength at which | | | | | | | | | |
| | transmittance of | | | | | | | | | |
| | light having wavelength | | | | | | | | | |
| | of 950 nm to 1,150 | | | | | | | | | |
| | nm is 50% at incident | | | | | | | | | |
| | angle of 30 degrees | | | | | | | | | |
| | [nm] | | | | | | | | | |

From the above results, in the optical filters of Examples 1 to 4, transmittance of visible light having a wavelength of 450 nm to 600 nm and near-infrared light having a wavelength of 1,100 nm to 1,200 nm is high, and transmittance of a region of the light having a wavelength of 725 nm to 1,000 nm between the transmission regions is controlled to be low.

On the other hand, in all of the optical filters of Examples 5 to 9, the transmittance of the near-infrared light having a wavelength of 1,100 nm to 1,200 nm was low.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2023-210431) filed on Dec. 13, 2023, the contents of which are incorporated herein by reference.

### INDUSTRIAL APPLICABILITY

The optical filter according to the present embodiment has spectral characteristics of excellent transmittance for visible light and specific near-infrared light, excellent shielding properties for other near-infrared light, and a small shift of a spectral curve even at a high incident angle. The optical filter is useful for applications of imaging devices such as cameras and sensors for transport machines, for which high performance has been achieved in recent years.

What is claimed is:

1. An optical filter comprising:
a dielectric multilayer film 1;
a light-absorbing layer;
a glass substrate; and
a dielectric multilayer film 2 in this order, wherein
the light-absorbing layer comprises a near-infrared ray absorbing dye, and
the optical filter satisfies all of the following spectral characteristics (i-1) to (i-6):
(i-1) an average transmittance of a light having a wavelength of 450 nm to 600 nm at an incident angle of 0 degrees is 85% or more,
(i-2) an absolute value of a difference between a wavelength at which a transmittance of a light having a wavelength of 550 nm to 750 nm is 50% at an incident angle of 0 degrees and a wavelength at which a transmittance of a light having a wavelength of 550 nm to 750 nm is 50% at an incident angle of 30 degrees is 10 nm or less,
(i-3) an average transmittance of a light having a wavelength of 725 nm to 1,000 nm at an incident angle of 0 degrees is 1% or less,
(i-4) a wavelength IR50 at which a transmittance of a light at an incident angle of 0 degrees is 50% is in a range of 1,000 nm to 1,150 nm,
(i-5) an average transmittance of a light having a wavelength of 1,100 nm to 1,200 nm at an incident angle of 0 degrees is 80% or more, and
(i-6) an absolute value of a difference between a wavelength at which a reflectance of a light at an incident angle of 5 degrees is 25% and a wavelength at which the reflectance is 85% in a wavelength of 550 nm to 850 nm is 20 nm or less when the light is incident from at least one main surface of the optical filter.

2. The optical filter according to claim 1, wherein the optical filter further satisfies the following spectral characteristic (i-7):
(i-7) an absolute value of a difference between a wavelength at which a transmittance of a light having a wavelength of 550 nm to 750 nm is 50% at an incident angle of 0 degrees and a wavelength at which a transmittance of a light having a wavelength of 950 nm to 1,150 nm is 50% at an incident angle of 0 degrees is 300 nm or more.

3. The optical filter according to claim 1, wherein in the spectral characteristic (i-5), the average transmittance of the light having a wavelength of 1,100 nm to 1,200 nm at an incident angle of 0 degrees is 85% or more.

4. The optical filter according to claim 1, wherein the optical filter further satisfies the following spectral characteristic (i-8):
(i-8) an absolute value of a difference between an average transmittance of a light having a wavelength of 1,100 nm to 1,200 nm at an incident angle of 0 degrees and an average transmittance of the light having a wavelength of 1,100 nm to 1,200 nm at an incident angle of 30 degrees is 6% or less.

5. The optical filter according to claim 1, wherein the optical filter further satisfies the following spectral characteristic (i-9):
(i-9) a wavelength at which an absorption loss amount of a light is 30% is in a range of 600 nm to 750 nm and in a range of 800 nm to 1,200 nm,
where, when a light is incident from either of the main surfaces, an (absorption loss amount)_{X} at a wavelength of X nm is defined as follows:
(absorption loss amount)_{X} [%]=100−(transmittance at incident angle of 0 degrees)−(reflectance at incident angle of 5 degrees).

6. The optical filter according to claim 1, wherein the dielectric multilayer film 1 has a thickness of 1,500 nm or more.

7. The optical filter according to claim 1, further comprising a dielectric multilayer film 3 between the light-absorbing layer and the glass substrate.

8. The optical filter according to claim 1, wherein the glass substrate is an ytterbium-containing glass substrate.

9. The optical filter according to claim 1, wherein the optical filter further satisfies the following spectral characteristic (i-10):
(i-10) an absolute value of a difference between a wavelength at which a transmittance of a light having a wavelength of 950 nm to 1,150 nm is 50% at an incident angle of 0 degrees and a wavelength at which a transmittance of the light having a wavelength of 950 nm to 1,150 nm is 50% at an incident angle of 30 degrees is 70 nm or less.

10. The optical filter according to claim 1, wherein the near-infrared ray absorbing dye in the light-absorbing layer comprises:
a dye having a maximum absorption wavelength at a wavelength of 700 nm or more and less than 730 nm;
a dye having a maximum absorption wavelength at a wavelength of 730 nm or more and less than 760 nm; and
a dye having a maximum absorption wavelength at a wavelength of 760 nm or more and less than 800 nm.

11. An imaging device comprising the optical filter according to claim 1.
